(19) United States
(12) Patent Application Publication
(10) Pub. No.: US 2026/0035866 A1
(43) Pub. Date: Feb. 5, 2026

(54) CONTAINER TREATMENT SYSTEM FOR PULP CONTAINERS

(71) Applicant: KRONES AG, Neutraubling (DE)

(72) Inventors: Ulrich LAPPE, Neutraubling (DE); Thomas ALBRECHT, Beilngries (DE); Frank WINZINGER, Regensburg (DE); Joerg ZACHARIAS, Koefering (DE)

(21) Appl. No.: 18/997,319

(22) PCT Filed: Jul. 17, 2023
(86) PCT No.: PCT/EP2023/069818

§ 371 Date: Jan. 21, 2025

(30) Foreign Application Priority Data
Jul. 21, 2022 (DE) 10 2022 118 292.4

(51) Int. Cl. D21J 3/10; F26B 15/10

(52) U.S. Cl. CPC D21J 3/10; F26B 15/10

(57) ABSTRACT

The invention relates to, inter alia, a container treatment system having a container producing apparatus for producing pulp containers from pulp, a tunnel dryer for drying the pulp containers, and a conveyor apparatus which connects the container producing apparatus to the tunnel dryer for transporting the pulp containers from the container producing apparatus to the tunnel dryer. Advantageously, the container treatment system allows a very large number of pulp containers to be produced and dried for a subsequent filling process because the drying process no longer acts as a bottleneck during the treatment process.

### TECHNICAL FIELD

The invention relates to a container treatment system and to a method for operating a container treatment system.

### TECHNICAL BACKGROUND

A current development trend in the food and beverage packaging industry is the production of containers from pulp. These so-called paper pulp containers or pulp containers can be produced, for example, as follows. First, a pasty paper pulp or a pulp can be introduced into a mold, which can consist of a plurality of mold bodies. After the pulp has been introduced, which completely wets the mold bodies, the water is removed from the pulp and at the same time it is ensured that the pulp adheres to the walls and base of the mold. The mold is then opened to produce a pulp container, such as a pulp bottle.

WO 2019/034707 A1 relates to a method and to an apparatus for producing a container as well as to a method and to a machine for filling and closing the container. A fiber-containing pulp is used to produce the container.

EP 1 285 994 A1 discloses a method for producing cellulose molded article. The method comprises a papermaking step comprising connecting each section to suction channels in a papermaking mold, starting to supply a cellulose slurry having a predetermined concentration to the cavity of the papermaking mold, and drawing the cellulose slurry through the suction channels to form a cellulose layer on the inner surface of the papermaking mold.

A disadvantage of the known prior art may be that the pulp containers have to dry for a comparatively long time after being produced. Only after drying can the pulp containers be transported to a filling system where they are filled and closed. Conventional drying of pulp containers in separate drying modules for each pulp container is also very complex, and therefore, in order to provide a large number of pulp containers for a modern filling plant, a very large number of drying modules would have to be provided. This is not very practical, and therefore a closed-loop controlled filling process without external delivery of the containers does not appear to be possible.

The object of the invention is that of providing an improved technique for treating pulp containers on an industrial scale, with which the above-mentioned disadvantages can preferably be overcome or at least mitigated.

### SUMMARY OF THE INVENTION

The object is achieved by the features of the independent claims. Advantageous developments are specified in the dependent claims and the description.

One aspect of the present disclosure relates to a container treatment system comprising a container producing apparatus for producing pulp containers from pulp (e.g., liquid, pasty or pulpy mixture of fibers, preferably plant fibers (e.g., wood fibers, paper fibers and/or hemp fibers), a liquid, preferably water, and optionally a binder), a tunnel dryer for drying the pulp containers and a conveyor apparatus. The conveyor apparatus connects the container producing apparatus and the tunnel dryer for transporting the pulp containers from the container producing apparatus to the tunnel dryer (e.g., directly or with the interposition of a coating apparatus for coating the inside of the pulp containers).

Advantageously, the container treatment system can allow a very large number of pulp containers to be produced and dried in order to be subsequently filled. As a result of the tunnel dryer, the process of drying the pulp containers that are still wet, which traditionally has the effect of a bottleneck, can no longer significantly limit the system capacity. Instead, the tunnel dryer can now achieve system capacities of significantly more than 10,000 containers per hour. The tunnel dryer can thus allow an integrated overall concept in which the pulp containers can be produced, dried, filled, closed, etc. in a single container treatment system in a continuous process and on an industrial scale.

In one embodiment, the conveyor apparatus comprises a circulating conveyor element, preferably a conveyor belt or conveyor chain, for directly transporting the pulp containers. This technique can be advantageously used if, after production, the pulp containers are already stable enough to be able to stand on a conveyor belt or the like by themselves, despite residual moisture.

Alternatively or additionally, the conveyor apparatus has a plurality of movable transport carriers (e.g., pucks) in or on which the pulp containers can be positioned, wherein the conveyor apparatus preferably has a circulating conveyor element, preferably a conveyor belt or a conveyor chain, on which the plurality of transport carriers are supported at their base. This technique can be advantageously used if the pulp containers are still not very stable after production due to residual moisture.

Alternatively or additionally, the conveyor apparatus is configured to transport the pulp containers, preferably upside down and held by their container necks. Preferably, the conveyor apparatus may comprise a plurality of clamping apparatuses for holding the container necks. Alternatively or additionally, the conveyor apparatus comprises a plurality of pins or mandrels for insertion into each container mouth of the pulp containers for holding the container necks and/or to support the container necks from the inside. This technique can be advantageously used if, after production, the pulp containers are already dimensionally stable despite residual moisture. Overhead transport can be particularly advantageous as no contaminants can fall into the containers from above.

In a further embodiment, the tunnel dryer has a circulating conveyor element, preferably a conveyor belt or conveyor chain, for directly transporting the pulp containers. Alternatively, the tunnel dryer comprises a plurality of movable transport carriers, in or on which the pulp containers can be positioned, wherein the tunnel dryer preferably has a circulating conveyor element, preferably a conveyor belt or a conveyor chain, on which the plurality of transport carriers are supported at their base. Alternatively, the tunnel dryer is configured to transport the pulp containers, preferably upside down and held by their container necks.

Preferably, the tunnel dryer may comprise a plurality of clamping apparatuses for holding the container necks and/or a plurality of pins or mandrels for insertion into each container mouth of the pulp containers for holding the container necks and/or to support the container necks from the inside. The tunnel dryer can therefore advantageously offer a transport concept that is suitable for each of the containers to be dried, which concept takes into account the dimensional stability and residual moisture of the pulp containers before they are dried.

In one embodiment, the tunnel dryer has a plurality of portions, preferably chambers, in which different drying temperatures and/or humidity values can be set. This advantageously allows an optimal drying/temperature-time profile for the pulp containers to be achieved.

In a further embodiment, the tunnel dryer has at least one heating device, preferably a radiant heating device, a microwave heating device, an infrared heating device, an electron beam heating device, a plasma heating device and/or a high frequency heating device. Advantageously, the heating device can be selected on the basis of the drying requirements each time. In addition, even complicated drying requirements can be met by combining a plurality of different heating devices. For example, a radiant heating device is more likely to dry a surface of the pulp containers. Microwaves, on the other hand, can dry more evenly and may very well dry from their inner core out, preferably resulting in fewer drying cracks in the pulp containers. In principle, instead of using water as a dispersing fluid, it is also possible to use a fluid in the pulp that is easier to evaporate or remove.

In a development, each portion at least has its own heating device. This advantageously makes it easy to individually set the temperature for each portion.

It is possible to provide separate open-loop and/or closed-loop control for one heating device, a plurality of heating devices or for each heating device. The input variable used can be an air temperature and/or a container temperature and/or a container humidity and/or other variables. In the case of an electric heater, for example, a current strength can serve as a manipulated variable. To measure the input variable(s), appropriate sensor(s) can be installed in and/or on the tunnel dryer.

In one variant, the tunnel dryer is single-level. Alternatively, the tunnel dryer can have several levels, preferably two levels. Alternatively, the tunnel dryer may comprise a conveyor apparatus (e.g., vertical screw conveyor or circulating conveyor element) which is helical, at least in portions, for transporting the pulp containers, preferably in a chimney or tower of the tunnel dryer. This advantageously makes it possible to achieve a large capacity with a comparatively small footprint. The structures mentioned are also particularly suitable for buffering the pulp containers.

In a further variant, the tunnel dryer has a waste heat utilization device for utilizing waste heat from drying and/or condensation heat from the condensation of water vapor generated during drying. Alternatively or additionally, the tunnel dryer may comprise a water recovery device, such as a condenser, for recovering water from water vapor generated during drying. Advantageously, a considerable amount of energy and water can thus be saved, since the tunnel dryer concept aims to dry a very large number of pulp containers, and therefore a large amount of waste heat and water can be recovered.

Recovered water can, for example, be returned (e.g., via a sloping line) and/or pumped back to the container producing apparatus.

In a further embodiment, the tunnel dryer is configured to buffer the pulp containers, preferably by accumulating the pulp containers, by exposing a buffer route through the tunnel dryer, by adjusting a conveying speed through the tunnel dryer and/or by conveying the pulp containers to a parking station of the tunnel dryer. Another function, namely buffering containers, can therefore advantageously be integrated in the tunnel dryer. Accordingly, a separate, installation space-consuming buffer route can advantageously be dispensed with.

In a further embodiment, the tunnel dryer is configured to thermally sterilize the pulp containers (e.g., by at least one heating device of the tunnel dryer). Another function, namely sterilizing containers, can therefore advantageously be integrated in the tunnel dryer. Accordingly, a separate (thermal) sterilization device can advantageously be dispensed with.

In a further embodiment, the tunnel dryer has a (drying) capacity of ≥10,000 containers per hour. The tunnel dryer can advantageously exploit its potential at high system capacities, as a result of which, as mentioned, the integrated overall concept of producing and filling pulp containers on an industrial scale in a common container treatment system is made possible.

In one embodiment, the container treatment system further comprises at least one of the following:
a pulp producing apparatus for producing pulp, preferably from fibers (e.g., plant fibers), water or a different dispersing fluid and a binder, wherein the pulp producing apparatus is fluidically connected to the container producing apparatus for supplying the pulp to the container producing apparatus;
a pre-drying apparatus for pre-drying the pulp containers, wherein the pre-drying apparatus is preferably arranged upstream of the tunnel dryer in terms of the container flow (e.g., integrated in the container producing apparatus and/or downstream of the container producing apparatus in terms of the container flow);
a coating apparatus for coating the inside of the pulp containers, preferably with a liquid-tight and/or gas-tight coating, wherein the coating apparatus is arranged, preferably directly, upstream or downstream of the tunnel dryer in terms of the container flow
a cleaning apparatus for cleaning the pulp containers, which is preferably arranged downstream of the tunnel dryer in terms of the container flow;
a filling apparatus for filling the pulp containers with a liquid or pasty filling material, which is arranged downstream of the tunnel dryer in terms of the container flow;
a closure apparatus for closing the pulp containers, which is arranged downstream of the tunnel dryer in terms of the container flow, wherein the closure apparatus is preferably connected to the, or another, tunnel dryer for receiving dried container closures, preferably pulp container closures, from the, or another, tunnel dryer;
a labeling apparatus for labeling the pulp containers, which is preferably arranged downstream of the tunnel dryer in terms of the container flow;
a printing apparatus for printing on the pulp containers, which is preferably arranged downstream of the tunnel dryer in terms of the container flow; and
a packaging apparatus for packaging the pulp containers, which is arranged downstream of the tunnel dryer in terms of the container flow;
a palletizing apparatus for palletizing packaged or individual pulp containers, which is arranged downstream of the tunnel dryer in terms of the container flow.

In a further embodiment, the container treatment system further comprises a closure producing apparatus for producing pulp container closures from pulp, wherein the closure producing apparatus is preferably connected to the tunnel dryer for conveying the pulp container closures to the tunnel dryer for drying the pulp container closures. Another function, namely drying and, if necessary, buffering container closures, can therefore advantageously be integrated in the tunnel dryer.

Preferably, the container producing apparatus has cavities in each of which a pulp container is produced. Preferably, at least two, more preferably at least five, particularly preferably at least ten, cavities are assigned to the tunnel dryer. In other words, during production, the pulp containers from at least two, more preferably at least five, particularly preferably at least ten, cavities are transported to a single tunnel dryer and dried thereby.

Preferably, the same can also be provided for the closures, either with a separate tunnel dryer assigned to a plurality of closure producing cavities, or with the same tunnel dryer.

Preferably, the tunnel dryer or a conveyor upstream or downstream thereof may have one or more nozzles which can introduce air into an interior of the pulp containers. Preferably, the nozzles can enter the containers. Preferably, the nozzles can be arranged on an apparatus which moves the nozzles synchronously with the containers.

Optionally, the tunnel dryer can additionally or alternatively have nozzles that can direct air to outside the containers.

It is possible for individual nozzles or all the nozzles to be adjustable so that, for example, containers of different sizes can be processed. For example, nozzles directed at the outer surface of the containers can be laterally advanced toward the containers in a horizontal direction. The stroke of entering nozzles can also be adjustable.

It is also possible that a volume flow (e.g., an air volume flow) applied to the nozzles can be adjusted by at least one valve in at least one line to the nozzles. A pressure applied to the nozzles can be adjustable and preferably even controlled using closed-loop control.

Another aspect of the present disclosure relates to a method for operating a container treatment system, preferably as disclosed herein. The method involves producing pulp containers from pulp (preferably from fibers (e.g., plant fibers), water or another dispersing fluid and a binder) by a container producing apparatus of the container treatment system. The method involves transporting the pulp containers from the container producing apparatus to a tunnel dryer of the container treatment system by a conveyor apparatus of the container treatment system and drying the pulp containers in the tunnel dryer (e.g., as they pass through the tunnel dryer). Advantageously, the method can achieve the same advantages that have already been described with reference to the container treatment system. The same applies to the following preferred embodiments of the method.

In one embodiment, the method comprises at least one of the following:
buffering the pulp containers in the tunnel dryer, preferably by accumulating the pulp containers, by exposing a buffer route through the tunnel dryer, by adjusting a conveying speed through the tunnel dryer and/or by conveying the pulp containers to a parking station of the tunnel dryer;
thermally sterilizing the pulp containers in the tunnel dryer;
utilizing waste heat from drying and/or condensation heat from the condensation of water vapor produced during drying by a waste heat utilization device of the tunnel dryer; and
recovering water produced during drying by a water recovery device of the tunnel dryer.

In another embodiment, the method further comprises at least one of the following:
producing pulp, preferably from fibers (e.g., plant fibers), a liquid (e.g., water or another dispersing fluid) and optionally a binder by a pulp producing apparatus of the container treatment system and supply the pulp from the pulp producing apparatus to the container producing apparatus;
pre-drying the pulp containers by a pre-drying apparatus of the container treatment system before drying the pulp containers, preferably to reduce or prevent shrinkage of the pulp containers;
coating the inside of the pulp containers with a liquid-tight and/or gas-tight coating by a coating apparatus of the container treatment system, wherein the inside is coated, preferably directly, before or after drying;
cleaning (e.g., rinsing or disinfecting) the pulp containers by a cleaning apparatus, preferably after drying the pulp containers;
filling the pulp containers with a liquid or pasty filling material by a filling apparatus of the container treatment system after drying the pulp containers;
closing the pulp containers by a closure apparatus of the container treatment system after drying the pulp containers;
labeling the pulp containers by a labeling apparatus of the container treatment system, preferably after drying the pulp containers;
printing on the pulp containers by a printing apparatus of the container treatment system, preferably after drying the pulp containers; and
packaging the pulp containers by a packaging apparatus of the container treatment system after drying the pulp containers; and
palletizing the pulp containers using a palletizing apparatus of the container treatment system after drying the pulp containers.

For example, the containers can be configured as bottles, cans, canisters, cartons, vials, etc.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a purely schematic representation of a container treatment system in accordance with an embodiment of the present disclosure;

FIG. 2 shows a schematic representation of a transport concept for transporting the pulp containers;

FIG. 3 shows a schematic representation of another transport concept for transporting the pulp containers;

FIG. 4 shows a schematic representation of another transport concept for transporting the pulp containers;

FIG. 5 shows a schematic representation of a tunnel dryer in accordance with an embodiment of the present disclosure;

FIG. 6 shows a schematic representation of a tunnel dryer in accordance with another embodiment of the present disclosure;

FIG. 7 shows a schematic representation of a tunnel dryer in accordance with another embodiment of the present disclosure;

FIG. 8 shows a purely schematic representation of a container treatment system in accordance with another embodiment of the present disclosure; and

FIG. 9 shows a purely schematic representation of a drying concept.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

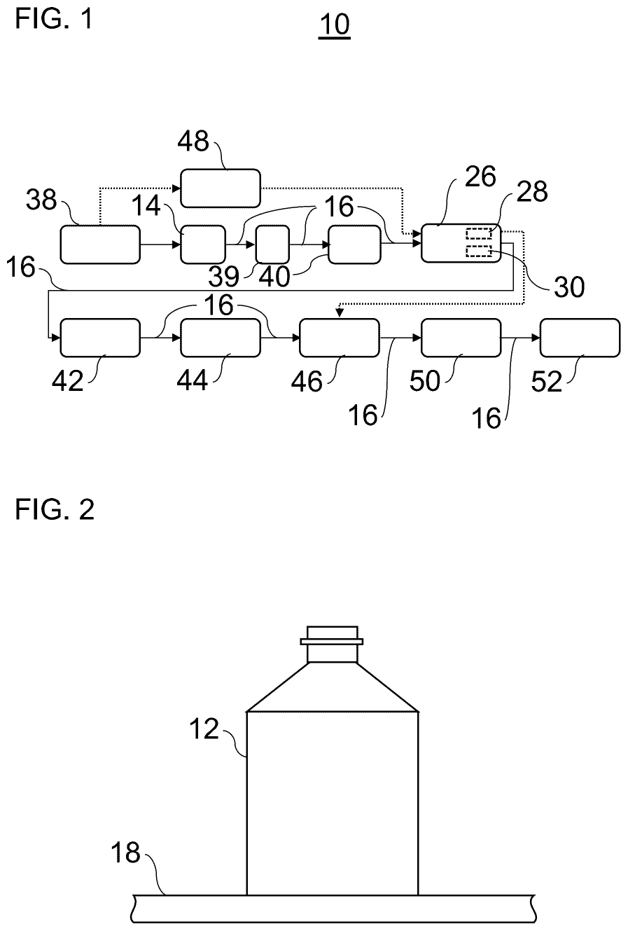

FIG. 1 shows a container treatment system 10 for producing and treating pulp containers 12 (see, for example, FIG. 2; not shown separately in FIG. 1).

The container treatment system 10 has a container producing apparatus 14, a conveyor apparatus 16 and a tunnel dryer 26. Optionally, the container treatment system 10 may further comprise a pulp producing apparatus 38, a pre-drying apparatus 39, a coating apparatus 40, a cleaning apparatus 42, a filling apparatus 44, a closure apparatus 46, a closure producing apparatus 48, a provision apparatus 50 and/or a packaging apparatus 52. Optionally, a palletizing apparatus can also be included (not shown in the drawings).

The aforementioned container treatment apparatuses 14, 26, 40, 42, 44, 46, 48 and 50 can, for example, each be configured as a rotary container treatment apparatus or as a linear container treatment apparatus. Said container treatment apparatuses 14, 26, 40, 42, 44, 46, 48 and 50 can each have a plurality of treatment stations for simultaneously treating a plurality of pulp containers 12 or for treating a plurality of pulp containers 12 with a temporal overlap.

The container producing apparatus 14 is configured to produce the pulp containers 12 from pulp. Preferably, the container producing apparatus 14 can produce each of the pulp containers 12 by a mold, e.g., as explained herein at the outset. The pulp can be applied to a wall of the mold for forming the pulp container 12. The mold is preferably made up of several parts.

The conveyor apparatus 16 connects the container producing apparatus 14 and the tunnel dryer 26 for transporting the pulp containers 12 from the container producing apparatus 14 to the tunnel dryer 26.

The conveyor apparatus 16 can, for example, directly connect the container producing apparatus 14 and the tunnel dryer 26 to one another (not shown in FIG. 1), i.e., without the interposition of a further container treatment apparatus for treating the pulp containers 12. Alternatively, the conveyor apparatus 16 can connect the container producing apparatus 14 and the tunnel dryer 26, for example with the interposition of at least one further container treatment apparatus for treating the pulp containers 12. As shown in FIG. 1, for example, the coating apparatus 40 can be arranged therebetween.

Optionally, the conveyor apparatus 16 can connect the container treatment apparatuses 26, 42, 44, 46, 50 and/or 52 to one another. It is also possible for the container treatment apparatuses 26, 40, 42, 44, 46, 50 and/or 52 to have their own conveyor apparatuses.

FIGS. 2 to 4 show preferred transport concepts for transporting the pulp containers 12, which concepts can be applied by the conveyor apparatus 16 and/or the conveyor apparatus of the container treatment apparatus 26, 40, 42, 44, 46, 50 and/or 52.

The conveyor apparatus in FIG. 2 can have at least one circulating conveyor element 18. The circulating conveyor element 18 can be, for example, a conveyor belt or a conveyor chain, for example a mat-top chain conveyor or a slatband chain conveyor. The conveyor element 18 can preferably support the pulp containers 12 at their base.

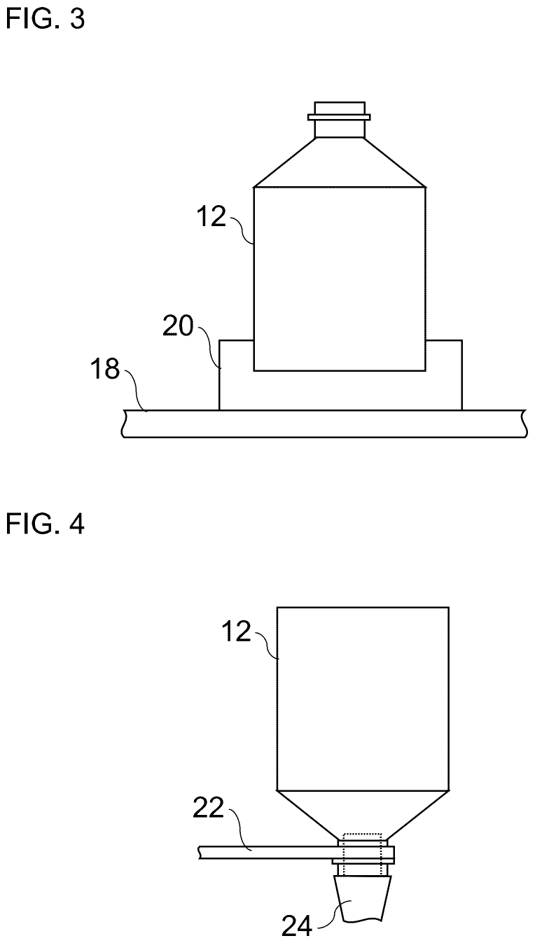

The conveyor apparatus in FIG. 3 can, in addition to the at least one circulating conveyor element 18, have a plurality of transport carriers 20 for transporting the pulp containers 12. The conveyor element 18 can preferably support the transport carriers 20 at their base. The transport carriers 20 can be transported by the conveyor element 18, whereby the pulp containers 12 are transported by the transport carriers 20.

The transport carriers 20 can support the pulp containers 12 at their base. The transport carriers 20 can each have one or more negative molds of a base portion or body of the pulp containers 12. Preferably, an upper side of the transport carriers 20 can have the negative shape. For example, the transport carriers 20 may have a bowl shape, tub shape or trough shape on the upper side, which is preferably adjusted to the shape of a base of the pulp container 12. The transport carriers 20 can, for example, tightly surround the bases of the pulp containers 12 or support the pulp containers 12 somewhat more loosely. Instead of standing, the pulp containers 12 can also be supported by the transport carriers 20 lying down, for example.

The transport carriers 20 can, for example, be substantially block-shaped, disk-shaped or plate-shaped. For example, the transport carriers 20 can be configured as so-called pucks. An underside of the transport carriers 20 can be configured to allow them to securely stand on the conveyor element 18. Preferably, an underside of the transport carriers 20 can be substantially flat or planar. The transport carriers 20 can be made of plastics materials or other materials, for example.

Even though FIG. 3 shows an embodiment in which a single transport carrier 20 supports a single pulp container 12, it is also possible for the transport carriers 20 to each support a plurality of pulp containers 12. For example, each transport carrier 20 can have one or more rows of receptacles for the pulp containers 12. For example, each transport carrier can support 20 5×5, 10×10, 15×15 or 20×20 pulp containers 12.

At the beginning of the transport route, the pulp containers 12 can be positioned in the transport carriers 20. At the end of a transport route, the pulp containers 12 can be removed from the transport carriers 20. The empty transport carriers 20 can then be transported back to the container producing apparatus 14, for example, in a return movement of the conveyor apparatus. Positioning and/or removal can be carried out, for example, using a pick-and-place system.

The conveyor apparatus in FIG. 4 can be configured to hold the pulp containers 12 by their container necks. Preferably, the pulp containers 12 can be transported upside down. Alternatively, it is also possible to transport the pulp containers 12 upright, for example.

The conveyor apparatus in FIG. 4 may have a plurality of clamping apparatuses 22 and/or a plurality of pins or mandrels 24. The clamping apparatuses 22 can be active or passive. The clamping apparatuses 22 can hold the container necks from the outside, preferably by clasping them. The pins or mandrels 24 can each be inserted into a container mouth of the pulp containers 12. The pins or mandrels can support the container necks, for example, at the container mouth of each of the pulp containers 12. It is also possible that the mandrels or pins 24 support the container necks from the inside, while the clamping apparatuses 22 hold the outside of the neck of the pulp containers 12.

The tunnel dryer 26, again shown by way of example in FIG. 1, is configured to dry or dehumidify the pulp containers 12. If the pulp containers 12 have already been coated, the tunnel dryer 26 can additionally dry the coating, if necessary. It is also possible for the tunnel dryer 26 to sterilize the pulp containers 12 by heating them.

Preferably, the tunnel dryer 26 can dry the pulp containers 12 to a moisture content of ≤2%. Preferably, the tunnel dryer 26 can have a capacity of ≥10,000 containers per hour. The tunnel dryer 26 can dry the pulp containers 12 as they are continuously transported through the tunnel dryer 26.

The tunnel dryer 26 can have a waste heat utilization device 28. Using the waste heat utilization device 28, the waste heat produced during drying of the pulp containers 12 can be utilized. Alternatively or additionally, the waste heat utilization device 28 can utilize condensation heat that arises during the condensation of water vapor generated during drying of the pulp containers 12. The waste heat can be utilized in any way by the waste heat utilization device 28, e.g., for internal heat recovery for supplying the recovered heat to the drying process in the tunnel dryer 26.

The tunnel dryer 26 can have a water recovery device 30. Using the water recovery device 30, water can be recovered from water vapor generated during drying of the pulp containers 12, e.g., by collecting the condensate and/or by using a condenser. The water recovery device 30 may have a water connection, e.g., a tap, for providing the recovered water.

It is possible that the water recovery device 30 is fluidically connected to the pulp producing apparatus 38 for supplying the recovered water to the pulp producing apparatus 38. Preferably, a pump can be arranged in the fluid connection.

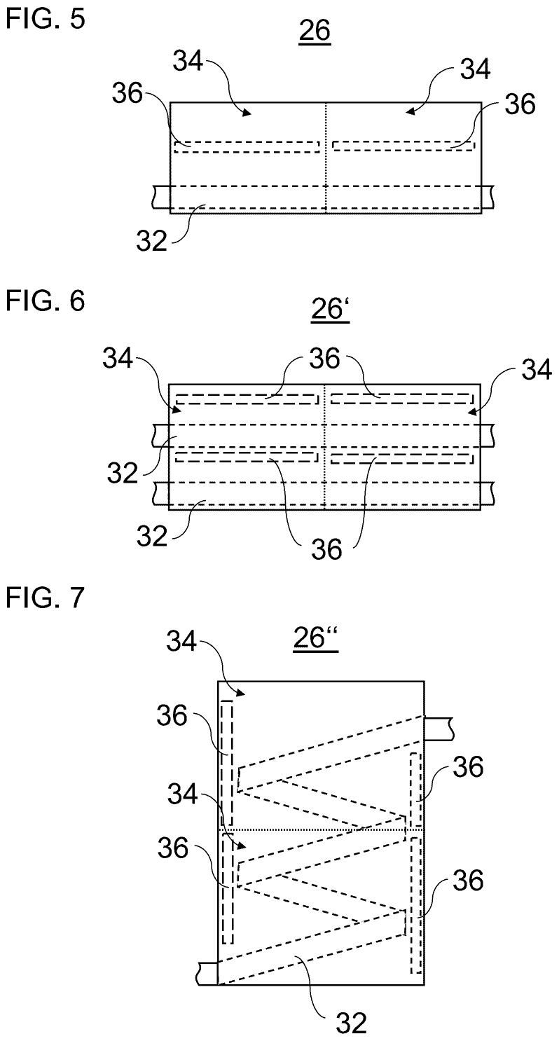

FIGS. 5 to 7 show embodiments of the tunnel dryer 26 by way of example.

The tunnel dryers 26, 26′ and 26″ can each comprise at least one conveyor apparatus 32 and at least one heating device 36.

The at least one conveyor apparatus 32 can transport the pulp containers through the tunnel dryer 26 during the drying process. The at least one conveyor apparatus 32 can, for example, be configured as already described with reference to FIGS. 2 to 4. The at least one conveyor apparatus 32 can extend between an inlet and an outlet of the tunnel dryer 26, 26′, 26″.

Preferably, the conveyor apparatus 32 of the tunnel dryer 26 can allow the pulp containers 12 to be buffered. Buffering can be made possible, for example, by accumulating the pulp containers 12, e.g., by blocking an outlet of the tunnel dryer 26. Buffering can also be made possible, for example, by exposing a buffer route through the conveyor apparatus 32, by adjusting a conveying speed of the conveyor apparatus 32 and/or by conveying the pulp containers 12 to a parking station of the tunnel dryer 26.

The tunnel dryer 26 in FIG. 5 can, for example, be a single-level tunnel dryer. The conveyor apparatus 32 can only extend in one plane, e.g., in a straight line or the shape of an oval or wound in another manner.

The tunnel dryer 26′ in FIG. 6 may be multi-level. Preferably, the tunnel dryer 26 is a double-level tunnel dryer. The tunnel dryer 26 can have at least two conveyor apparatuses 32 arranged on different levels. Preferably, one of the conveyor apparatuses 32 is arranged above another of the conveyor apparatuses 32. The conveyor apparatuses 32 can in turn each be straight, oval or wound in another way. The conveyor apparatuses 32 can extend substantially in parallel.

The tunnel dryer 26″ from FIG. 6 can have a conveyor apparatus 32 that is helical at least in portions. The helical shape can be vertically aligned. The conveyor apparatus 32 can be arranged, for example, in a chimney or a tower of the tunnel dryer 26″.

The tunnel dryer 26, 26′, 26″ can be divided into a plurality of portions 34 by a plurality of heating devices 36, if desired. Different temperatures can be set in the portions 34 by the heating devices 36 and/or can have different levels of humidity. In a first portion, a different drying temperature and/or level of humidity may prevail than in a second portion. Preferably, each portion 34 is assigned at least its own heating device 36. The portions 34 may be adjacent to one another or spaced apart from one another. The portions 34 may merge into one another. The portions 34 can, for example, be configured as chambers of the tunnel dryer 26.

The at least one heating device 36 can, for example, have at least one radiant heating device, microwave heating device, infrared heating device, electron beam heating device, plasma heating device and/or high frequency heating device.

Referring once again to FIG. 1, an optional pulp producing apparatus 38 is shown. The pulp producing apparatus 38 can be configured to produce pulp, for example, from fibers, water and a binder. The fibers may preferably be plant fibers, such as paper fibers, wood fibers and/or hemp fibers. The binder can, for example, be an adhesive such as glue.

The pulp producing apparatus 38 can be fluidically connected to the container producing apparatus 14. The pulp producing apparatus 38 can supply the pulp produced thereby to the container producing apparatus 14 via the fluidic connection. The container producing apparatus 14 can receive the pulp from the pulp producing apparatus 38 and produce the pulp containers 12 therefrom.

The pre-drying apparatus 39 can be configured to pre-dry the pulp containers 12. Preferably, the pre-drying apparatus 39 can pre-dry the pulp containers 12 before they reach the tunnel dryer 26. Preferably, pre-drying of the pulp containers 12 by the pre-drying apparatus 39 can be adjusted such that the pulp containers 12 are already pre-dried to such an extent that no shrinkage, substantially no shrinkage or only a manageable amount of shrinkage, which can be expected or calculated, for example, of the pulp containers 12 occurs during further drying (e.g., in the tunnel dryer 26). Preferably, the pulp containers 12 can be pre-dried by supplying heat and/or air to the pulp containers 12.

It is also possible for the pulp containers 12 to each be pre-dried in a mold in which each of the pulp containers 12 is received. The mold can be adjusted to a shape of the pulp container 12 in such a way that shrinkage of the pulp containers 12 is counteracted or prevented. The mold can, for example, be a mold of the container producing apparatus 14 or be included in a corresponding transport carrier 20.

It is possible for the pre-drying apparatus 39 to be integrated in the container producing apparatus 14. The pre-drying apparatus 39 can also be arranged separately from the container producing apparatus 14, e.g., downstream of the container producing apparatus 14, upstream or downstream of the coating apparatus 40 and/or upstream of the tunnel dryer 26. It is also possible that a first pre-drying apparatus is integrated in the container producing apparatus 14 and a second pre-drying apparatus is arranged separately from the container producing apparatus 14.

The coating apparatus 40 can be configured to coat the inside of the pulp containers 12. Preferably, the coating apparatus 40 can apply a gas-tight and/or liquid-tight coating to an inner wall surface of the pulp containers 12. The coating apparatus 40 can be arranged, preferably directly, upstream of the tunnel dryer 26 in terms of the container flow, as shown in FIG. 1. Alternatively, the coating apparatus 40 can, for example, be arranged directly downstream of the tunnel dryer 26 in terms of the container flow.

The cleaning apparatus 42 can be configured to clean the pulp containers 12. Preferably, the cleaning apparatus 42 can dry, clean or disinfect the pulp containers 12, for example by rinsing or flushing them with a gas. The cleaning apparatus 42 can preferably be arranged downstream of the tunnel dryer 26 in terms of the container flow and optionally of the coating apparatus 40.

The filling apparatus 44 can be configured to fill the pulp containers 12 with a liquid or pasty filling material. The filling apparatus 44 can fill the pulp containers 12 with a beverage or food. Preferably, the filling apparatus 44 can have a plurality of filling stations for filling the pulp containers 12. The plurality of filling stations can, for example, be arranged around a circumference of a rotary filling apparatus (filler carousel). Alternatively, the plurality of filling stations can be arranged, for example, next to one another and/or one behind the other in a row in a linear filling apparatus. The filling apparatus 44 can preferably be arranged downstream of the tunnel dryer 26 in terms of the container flow and optionally of the coating apparatus 40 and/or the cleaning apparatus 42.

The closure apparatus 46 can be configured to close the pulp containers 12. For example, the closure apparatus 46 can close the pulp containers 12 with a lid, a cork, a crown cap, a screw cap or a film. The closure apparatus 46 can have a plurality of closing stations for closing a plurality of pulp containers 12 either simultaneously or with a temporal overlap. For example, the closing stations can be arranged around a circumference of a rotary closure apparatus (closure carousel). Alternatively, the plurality of closing stations can be arranged, for example, next to each other and/or one behind the other in a row in a linear closure apparatus. The closure apparatus can be arranged downstream of the filling apparatus 44 in terms of the container flow.

Optionally, the closure apparatus 46 can close the pulp containers 12 with a pulp closure made of pulp. For example, it is possible that the pulp closures are produced by the closure producing apparatus 48 from pulp from the pulp producing apparatus 38. Preferably, the closure producing apparatus 48 may be connected to the tunnel dryer 26 for transporting the pulp closures to the tunnel dryer 26. In the tunnel dryer 26, the pulp closures can be dried and optionally buffered, as already described with reference to the pulp containers 12. The tunnel dryer 26 may be connected to the closure apparatus 46 for transporting the dried pulp closures from the tunnel dryer 26 to the closure apparatus 46.

The provision apparatus 50 can be configured, for example, as a labeling apparatus or printing apparatus.

The labeling apparatus can be configured to label the pulp containers 12 or to provide them with a label. The label can be applied to the pulp container 12 by the labeling apparatus, for example using an adhesive. Alternatively, the label may, for example, be a self-adhesive label, be pulled or slid over the pulp container 12, or shrunk onto the pulp container 12.

The printing apparatus can be configured to print on the pulp containers 12. Preferably, the printing apparatus can print on the pulp containers 12 in a direct printing process. For example, the printing apparatus may be a laser printing apparatus.

The packaging apparatus 52 may be configured to package the pulp containers 12. For example, the packaging apparatus 52 can combine a plurality of pulp containers 12, for example two, four or six pulp containers 12, into one package in each case.

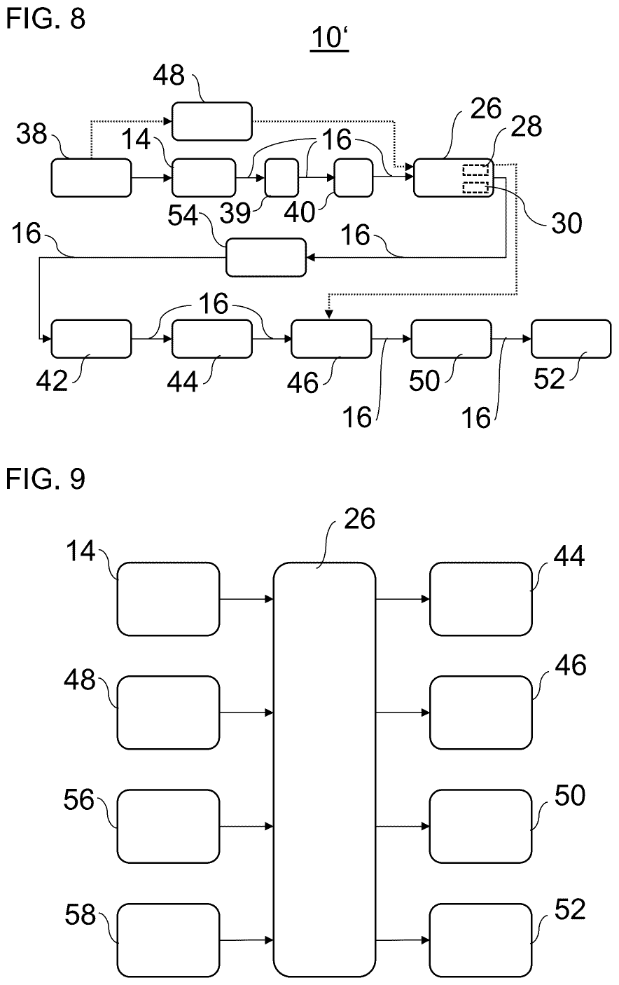

FIG. 8 shows a container treatment system 10′ which is modified with respect to the container treatment system 10 in FIG. 1.

The container treatment system 10′ can have a buffer station 54. If the buffer station 54 is present, the buffer functionality of the tunnel dryer 26 can be dispensed with, for example, if desired.

The buffer station 54 can be arranged downstream of the tunnel dryer 26 in terms of the container flow. The tunnel dryer 26 and the buffer station 54 may be connected to one another by the conveyor apparatus 16 for transporting pulp containers 12 from the tunnel dryer 26 to the buffer station 54. The dried pulp containers 12 can be buffered in the buffer station 54, if desired.

For example, the buffer station 54 can be configured as a sterile room or a sterile hall in which the pulp containers 12 can be intermediately stored. The pulp containers 12 buffered in the buffer station 54 can then, if desired, be transported by the conveyor apparatus 16 to the cleaning apparatus 42 (if present) or the filling apparatus 44.

It is also possible that the buffer station 54 is configured as a transfer station in which the pulp containers 12 are loaded into transport containers, preferably sterile ones. Loading can be carried out, for example, using pick-and-place apparatuses. The transport containers can, for example, be the size of a pallet cage or a truck container. After loading, the transport containers can be closed and transported for further treatment, e.g., by truck, train, etc. This also makes it possible, for example, to supply remote filling systems with pulp containers 12, in which the transport containers can be unloaded again. Preferably, the transport containers can be connected in a sterile manner to a docking station of the filling system to allow sterile unloading.

FIG. 9 schematically shows how the concept of drying and buffering in the tunnel dryer 26 can be extended.

The possibility of drying and optionally buffering the pulp containers 12 in the tunnel dryer 26 while passing from the container producing apparatus 14 to the filling apparatus 44 has already been described. The possibility of drying and optionally buffering the pulp closures in the tunnel dryer 26 while passing from the closure producing apparatus 48 to the closure apparatus 46 has also already been described. Due to the buffering, the tunnel dryer 26 can preferably serve as a comparatively large intermediate storage facility for the pulp containers 12 and the pulp container closures. Storage can be random, i.e., as mass storage, or organized. For example, different pulp containers 12 and pulp container closures can also be intermediately stored.

In addition, the concept can be extended such that labels for the provision apparatus 50 and/or carriers for the packaging apparatus 52 are also made from pulp.

Pulp labels may be made from pulp by a label producing apparatus 56, such as the pulp producing apparatus 38. The pulp labels can be dried and optionally buffered in the tunnel dryer 26. The pulp labels can be applied to the pulp containers 12 and optionally printed on by the provision apparatus 50.

Pulp carriers (e.g., pulp boxes or pulp container carriers) can be produced from pulp by a carrier producing apparatus 58, e.g., by the pulp producing apparatus 38. The pulp carriers can be dried and optionally buffered in the tunnel dryer 26. The pulp carriers can be used by the packaging apparatus 52 to package the pulp containers 12.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or the configuration of the container producing apparatus, the tunnel dryer, and/or the conveyor apparatus of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 container treatment system
12 pulp container
14 container producing apparatus
16 conveyor apparatus
18 conveyor element
20 transport carrier
22 clamping apparatus
24 pin or mandrel
26 tunnel dryer
28 waste heat utilization device
30 water recovery device
32 conveyor apparatus
34 portion
36 heating device
38 pulp producing apparatus
39 pre-drying apparatus
40 coating apparatus
42 cleaning apparatus
44 filling apparatus
46 closure apparatus
48 closure producing apparatus
50 provision apparatus
52 packaging apparatus
54 buffer station
56 label producing apparatus
58 carrier producing apparatus

1-15. (canceled)

16. A container treatment system, comprising:
a container producing apparatus for producing pulp containers from pulp;
a tunnel dryer for drying the pulp containers; and
a conveyor apparatus which connects the container producing apparatus and the tunnel dryer for transporting the pulp containers from the container producing apparatus to the tunnel dryer.

17. The container treatment system according to claim 16, wherein at least one of:
the conveyor apparatus has a circulating conveyor element for directly transporting the pulp containers;
the conveyor apparatus has a plurality of movable transport carriers in or on which the pulp containers can be positioned, and on which the plurality of transport carriers (20) are supported at their base; and
the conveyor apparatus is configured to transport the pulp containers held by their container necks.

18. The container treatment system according to claim 17, wherein at least one of:
the circulating conveyor element is one of a conveyor belt and a conveyor chain;
the conveyor element includes one of a conveyor belt and a conveyor chain;
the conveyor apparatus is configured to transport the pulp containers held by their container necks upside down; and
at least one of:
the conveyor apparatus has a plurality of clamping apparatuses for holding the container necks; and
the conveyor apparatus has a plurality of pins or mandrels for insertion into each container mouth of the pulp containers for at least one of holding the container necks and to support the container necks from the inside.

19. The container treatment system according to claim 16, wherein one of:
the tunnel dryer has a circulating conveyor element for directly transporting the pulp containers;
the tunnel dryer has a plurality of movable transport carriers in or on which the pulp containers can be positioned; and
the tunnel dryer is configured to transport the pulp containers held by their container necks.

20. The container treatment system according to claim 16, wherein:
the tunnel dryer has a plurality of portions wherein in the portions at least one of different drying temperatures and different humidity values can be set.

21. The container treatment system according to claim 20, wherein:
each portion at least has its own heating device.

22. The container treatment system according to claim 16, wherein:
the tunnel dryer has at least one heating device.

23. The container treatment system according to claim 16, wherein one of:
the tunnel dryer is a single-level tunnel dryer;
the tunnel dryer is a multi-level tunnel dryer; and
the tunnel dryer has a conveyor apparatus for transporting the pulp containers that is helical, at least in portions thereof.

24. The container treatment system according to claim 16, wherein at least one of:
the tunnel dryer has a waste heat utilization device for utilizing waste heat from at least one of drying and condensation heat from the condensation of water vapor generated during drying; and
the tunnel dryer has a water recovery device for recovering water from water vapor generated during drying.

25. The container treatment system according to claim 16, wherein at least one of:
the tunnel dryer is configured to buffer the pulp containers; and
the tunnel dryer is configured to thermally sterilize the pulp containers.

26. The container treatment system according to claim 16, wherein at least one of:
the tunnel dryer has a circulating element for directly transporting the pulp containers;
a plurality of transport carriers are supported at their base on the circulating element;
the tunnel dryer is configured to transport the pulp containers held by their container necks upside down;
the tunnel dryer has a plurality of chambers;
the tunnel dryer has at least one heating device that includes at least one of a radiant heating device, a microwave heating device, an infrared heating device, an electron beam heating device, a plasma heating device and a high frequency heating device;
the tunnel dryer is a double-level tunnel dryer;
the tunnel dryer has a conveyor apparatus for transporting the pulp containers that is helical in a chimney or tower of the tunnel dryer;
the tunnel dryer is configured to buffer the pulp containers at least one of by accumulating the pulp containers, by opening-up a buffer route through the tunnel dryer, by adjusting a conveying speed through the tunnel dryer and by conveying the pulp containers to a parking station of the tunnel dryer; and
at least one of:
the tunnel dryer has a plurality of clamping apparatuses for holding the container necks; and
the tunnel dryer has a plurality of pins or mandrels for insertion into a container mouth of the pulp containers for at least one of holding the container necks and to support the container necks from the inside.

27. The container treatment system according to claim 16, wherein:
the tunnel dryer has a capacity of ≥10,000 containers per hour.

28. The container treatment system according to claim 16, further comprising at least one of the following features:
a pulp producing apparatus for producing pulp, wherein the pulp producing apparatus is fluidically connected to the container producing apparatus for supplying the pulp to the container producing apparatus;
a pre-drying apparatus for pre-drying the pulp containers, wherein the pre-drying apparatus is arranged upstream of the tunnel dryer in terms of a container flow;
a coating apparatus for coating an inside of the pulp containers, wherein the coating apparatus is arranged upstream or downstream of the tunnel dryer in terms of a container flow;
a cleaning apparatus for cleaning the pulp containers, which is arranged downstream of the tunnel dryer in terms of a container flow;
a filling apparatus for filling the pulp containers with a liquid or pasty filling material, which is arranged downstream of the tunnel dryer in terms of a container flow;
a closure apparatus for closing the pulp containers, which is arranged downstream of the tunnel dryer in terms of a container flow;
a labeling apparatus for labeling the pulp containers, which is arranged downstream of the tunnel dryer in terms of a container flow;
a printing apparatus for printing on the pulp containers, which is arranged downstream of the tunnel dryer in terms of a container flow;
a packaging apparatus for packaging the pulp containers, which is arranged downstream of the tunnel dryer in terms of a container flow; and
a palletizing apparatus for palletizing packaged or individual pulp containers, which is arranged downstream of the tunnel dryer in terms of a container flow.

29. The container treatment system according to claim 28, wherein at least one of:
the pulp is produced from fibers, water and a binder;
the coating apparatus coats the inside of the pulp containers with at least one of a liquid-tight coating and a gas-tight coating;
the coating apparatus is arranged directly upstream or downstream of the tunnel dryer in terms of the container flow;
the closure apparatus is connected to the tunnel dryer or to another tunnel dryer for receiving dried container closures from the tunnel dryer or to another tunnel dryer.

30. The container treatment system according to claim 16, wherein at least one of:
one of the conveyor apparatus and the tunnel dryer has a circulating conveyor element that includes a conveyor belt or a conveyor chain, on which the plurality of transport carriers are supported at their base; and
the container treatment system includes a closure apparatus for closing the pulp containers, which is arranged downstream of the tunnel dryer in terms of a container flow, and the closure apparatus is connected to the tunnel dryer or to another tunnel dryer for receiving pulp container closures from the tunnel dryer or to another tunnel dryer.

31. The container treatment system according to claim 16, further comprising:
a closure producing apparatus for producing pulp container closures from pulp, wherein the closure producing apparatus is connected to the tunnel dryer for conveying the pulp container closures to the tunnel dryer for drying the pulp container closures.

32. A method for operating a container treatment system, comprising:
producing pulp containers from pulp by a container producing apparatus of the container treatment system;
transporting the pulp containers from the container producing apparatus to a tunnel dryer of the container treatment system by a conveyor apparatus of the container treatment system; and
drying the pulp containers in the tunnel dryer.

33. The method according to claim 32, further comprising at least one of the following:
buffering the pulp containers in the tunnel dryer;
thermally sterilizing the pulp containers in the tunnel dryer;
utilizing waste heat from at least one of drying and condensation heat from the condensation of water vapor generated during drying by a waste heat utilization device of the tunnel dryer; and
recovering water produced during drying by a water recovery device of the tunnel dryer.

34. The method according to claim 32, further comprising at least one of the following features:
producing pulp by a pulp producing apparatus of the container treatment system and supplying the pulp from the pulp producing apparatus to the container producing apparatus;
pre-drying the pulp containers by a pre-drying apparatus of the container treatment system before drying the pulp containers;
coating an inside of the pulp containers with at least one of a liquid-tight and gas-tight coating by a coating apparatus of the container treatment system, wherein the inside is coated before or after the drying;
cleaning the pulp containers by a cleaning apparatus after the drying the pulp containers;
filling the pulp containers with a liquid or pasty filling material by a filling apparatus of the container treatment system after the drying the pulp containers;
closing the pulp containers by a closure apparatus of the container treatment system after the drying the pulp containers;
labeling the pulp containers by a labeling apparatus of the container treatment system after the drying the pulp containers;
printing on the pulp containers by a printing apparatus of the container treatment system after the drying the pulp containers;
packaging the pulp containers by a packaging apparatus of the container treatment system after the drying the pulp containers; and
palletizing the pulp containers by a palletizing apparatus of the container treatment system after the drying the pulp containers.

35. The method according to claim 32, further comprising at least one of the following:
buffering the pulp containers in the tunnel dryer, at least one of by accumulating the pulp containers, by opening-up a buffer route through the tunnel dryer, by adjusting a conveying speed through the tunnel dryer and by conveying the pulp containers to a parking station of the tunnel dryer;
producing pulp from fibers, a liquid and a binder by a pulp producing apparatus of the container treatment system and supplying the pulp from the pulp producing apparatus to the container producing apparatus;
pre-drying the pulp containers by a pre-drying apparatus of the container treatment system before drying the pulp containers to reduce or prevent shrinkage of the pulp containers;
coating an inside of the pulp containers with at least one of a liquid-tight and gas-tight coating by a coating apparatus of the container treatment system, wherein the inside is coated directly before or after the drying; and
operating the container treatment system having a container producing apparatus for producing pulp containers from pulp, a tunnel dryer for drying the pulp containers, and a conveyor apparatus which connects the container producing apparatus and the tunnel dryer for transporting the pulp containers from the container producing apparatus to the tunnel dryer.
